(19) United States
(12) Patent Application Publication
(10) Pub. No.: US 2008/0192066 A1
(43) Pub. Date: Aug. 14, 2008

(54) RASTER OPERATION TABLE CONVERSION FOR COLOR SPACES

(75) Inventor: CHING-WEI CHANG, VANCOUVER, WA (US)

Correspondence Address: Stolowitz Ford Cowger LLP/Sharp, 621 SW Morrison St, Suite 600, Portland, OR, 97205, US

(73) Assignee: SHARP LABORATORIES OF AMERICA, INC., CAMAS, WA (US)

(21) Appl. No.: 11/674,616

(22) Filed: Feb. 13, 2007

(51) Int. Cl. G09G 5/02

(52) U.S. Cl. 345/601

(57) ABSTRACT

A conversion table includes a conversion index number corresponding to a logical operation identified in a raster table. The conversion index number provided in the conversion table is mapped from a reference index number provided in the raster table, wherein the reference index number is associated with a raster image operation of one or more RGB operands defined in a first color space. The logical operation may be performed on one or more operands defined in a second color space.

### TECHNICAL FIELD

The invention relates to color image rendering, including a raster image operation as between a color space associated with a projected image and a color space associated with printed media.

### BACKGROUND

Printer control language (PCL) logical operations are typically defined in a red, green, blue (RGB) device color space. The logical operations are stored in a macro table or raster operation (ROP) table that may hold a fixed number of entries. Some ROP tables include 256 entries.

For a RGB printer, native color rendering in PCL color provides color rendering from an input RGB color space to a device RGB color space. RGB halftoning is applied first, followed by the logical operations. Next, bits associated with the RGB colors are inverted to prepare the image for printing in a CMY color space.

For a CMYK printer, color management modules are used to convert the RGB input color directly to the CMYK printer color. Halftoning, as well as the logical operations, are performed in the CMYK color space.

Certain raster operations performed in RGB color space may be incompatible with raster operations performed in CMY color space. Raster operations performed in the CMY space slow down overall color rendering processes. Furthermore, logical operations performed for CMYK ROP may introduce K handling issues such as over-saturation, leading to poor image quality or wasted toner.

The present invention addresses these and other problems associated with the prior art.

### BRIEF DESCRIPTION OF THE DRAWINGS

FIG. 1 illustrates an example block diagram of a print model operation in printer control language.

FIG. 2 illustrates an example block diagram of a logical operation in a second color space.

FIG. 3 illustrates an example block diagram of a raster operation (ROP) system including a monitor and a printer.

FIG. 4 illustrates an example block diagram of a ROP system including a lookup table and a raster table.

FIG. 5 illustrates an example lookup table.

FIG. 6 illustrates an example raster table.

FIG. 7A illustrates an example logical operation for a raster image operation between CMY and CMYK color spaces.

FIG. 7B illustrates a revised logical operation of the raster image operation shown in FIG. 7A, known in the art.

FIG. 7C illustrates a further example logical operation for a raster image operation between CMY and CMYK color spaces.

FIG. 7D illustrates a revised logical operation of the raster image operation shown in FIG. 7C, known in the art.

FIG. 7E illustrates an example of an improved logical operation in the CMYK color space, with reference to the raster image operation shown in FIG. 7C.

FIG. 7F illustrates a further example of an improved logical operation in the CMYK color space, with reference to the raster image operation shown in FIG. 7A.

FIG. 8 illustrates an example method of an improved raster operation.

FIG. 9 illustrates an example method for an improved raster image operation in the CMYK color space.

### SUMMARY OF THE INVENTION

A conversion table includes a conversion index number corresponding to a logical operation identified in a raster table. The conversion index number provided in the conversion table is mapped from a reference index number provided in the raster table, wherein the reference index number is associated with a raster image operation of one or more RGB operands defined in a first color space. The logical operation may be performed on one or more operands defined in a second color space.

An improved system for selecting a raster image operation is herein disclosed. A raster macro table includes a reference index number representing a first logical operation of one or more RGB operands in a first color space. A lookup table includes a conversion index number representing a second logical operation of one or more operands in a second color space. The reference index number is mapped to the conversion index number, where a designation of the reference index number results in an application of the second logical operation rather than, and different from, the first logical operation.

An improved method for selecting a raster image operation is herein disclosed. The method includes selecting a reference index number corresponding to a first logical operation associated with a first set of operands, and mapping the reference index number to a conversion index number, where the conversion index number corresponds to a second logical operation different than the first logical operation. The method further includes operating on a second set of operands according to the second logical operation, wherein the first set of operands is associated with a first color space, and the second set of operands is associated with a second color space.

The invention will become more readily apparent from the following detailed description of a preferred embodiment of the invention which proceeds with reference to the accompanying drawings.

### DESCRIPTION OF EXAMPLE EMBODIMENTS

Printing a graphic image can be complicated. Images which are displayed on computer monitors or otherwise projected for human perception may be defined by a first color space. Monitors provide an exceptionally large range of hue, saturation and intensity of the colors displayed. For example, it is not uncommon for monitors to have the capability of providing 32 bits worth of color data. Color space models for projected images typically include tuples of numbers, such as red, green and blue, otherwise known as the RGB color space. In the RGB color space, red, green and blue are often each represented by an 8 bit range of color variation.

Graphic devices such as printers, on the other hand, typically include but 3 or 4 bits worth of color variation. Although color space models for printers may also include tuples of numbers, and in some cases the addition of black, each of the tuples are limited to bitonal representation of 1 bit. That is, either on or off. Printed images are often defined by a cyan, magenta and yellow (CMY) color space. Some printers include a separate toner for black (K), in which case the images may be defined by a CMYK color space.

Printed images also differ greatly from projected images by the way color is perceived by a human observer. A monitor uses a color space defined by an additive model, that is, where red green and blue are added together to create different colors. Printed images, on the other hand, us a color space that is defined by a subtractive model, that is, where a person observes only those colors which are not absorbed by the printed images.

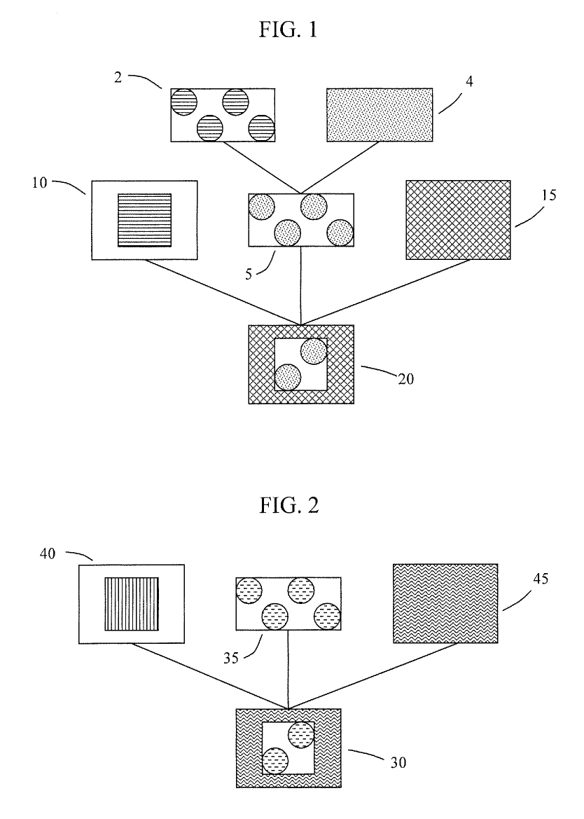

FIG. 1 illustrates an example block diagram of a print model operation in printer control language (PCL). The print model operation represents an example operation of combining different overlapping or coexisting images to provide a resultant image 20. The images may be defined by the RGB color space or any other color space such as CMY or CMYK.

A pattern 2 is shown as included a pattern of alternating circles or dots. The pattern 2 may not have any color associated with it, rather is may provide only a structure or geometry. In one embodiment, the pattern 2 is designated by black, such that the circles are black dots. A foreground color 4 may be combined with the pattern 2 to provide the pattern 2 with a designated color, namely the foreground color 4. A logical OR operation may be performed, such that combining the pattern 2 with the foreground color 4 results in a texture 5. Texture 5 is shown as including the dots of the pattern 2 having a color defined by the foreground color 4. The space around and between the dots may not have any color associated with it, or it may be designated as white.

The pattern 2 may be identified as being transparent or opaque. Using an 8-bit numbering convention, the pattern 2 may be defined as including black dots designated by the color tuple (0,0,0) surrounded by white space designated by the color tuple (255,255,255). The foreground color 4 may be designated by a color tuple such as (0,255,255), which in an RGB color space designates cyan. Assuming the pattern 2 is defined as being transparent, performing the OR logical operation on the pattern 2 and foreground color 4 results in the area within the circles or dots becoming cyan (0,255,255) in the resultant texture 5. Assuming the white area is defined as being opaque, the white area may remain white (255,255,255) regardless of the logical operation.

A source image 10 is shown as including a square surrounded by white. The square may be designated as black (0,0,0) or some other color tuple. Similarly, the area around the square may be some tuple other than white. A destination image 15 is shown as being a uniform color throughout. A logical operation may be performed on the texture 5, source image 10 and the destination image 15 that results in a new destination or resulting image 20. The logical operation may include one or more of the following functions of AND, OR, NOT and XOR.

The texture 5, the source image 10 and the destination image 15, may be referred to collectively as operands. The three operands may be identified as T, S and D, respectively. Where the operands are defined by the RGB color space, they may be referred to as RGB operands. Similarly, where the resulting image 20 is defined by the RGB color space, it may be referred to as an RGB image.

FIG. 2 illustrates an example block diagram of a logical operation in a second color space. The second color space may be defined by the CMY color space, or the CMYK color space for example. The logical operation represents an example operation of combining different overlapping or coexisting images to provide a resultant image 30. Combined images may include a texture 35, source image 40 and destination image 45.

The texture 35, the source image 40 and the destination image 45, may be referred to collectively as operands. The three operands may be identified as T, S and D, respectively. Where the operands are defined by the CMY color space, they may be referred to as CMY operands. Similarly, where the resulting image 30 is defined by the CMY color space, it may be referred to as a CMY image.

The CMY texture 35 may be defined similar to the RGB texture 5 of FIG. 1, as a logical operation of a pattern and a foreground color. The color tuples in a CMY color space are designated by the colors cyan, magenta and yellow, instead of the red, green and blue color tuples of the RGB color space. In the CMY color space, black may be designated by the color tuple (255,255,255) whereas white may be designated by the color tuple (0,0,0). Black may also be printed by a separate toner for black (K), in which case black may be designated by the color tuple (0,0,0,255) in CMYK color space.

A logical operation may be performed on the CMY texture 35, the CMY source image 40 and the CMY destination image 45 that results in a new destination image or resulting CMY image 30. The logical operation may include one or more of the following functions of AND, OR, NOT and XOR.

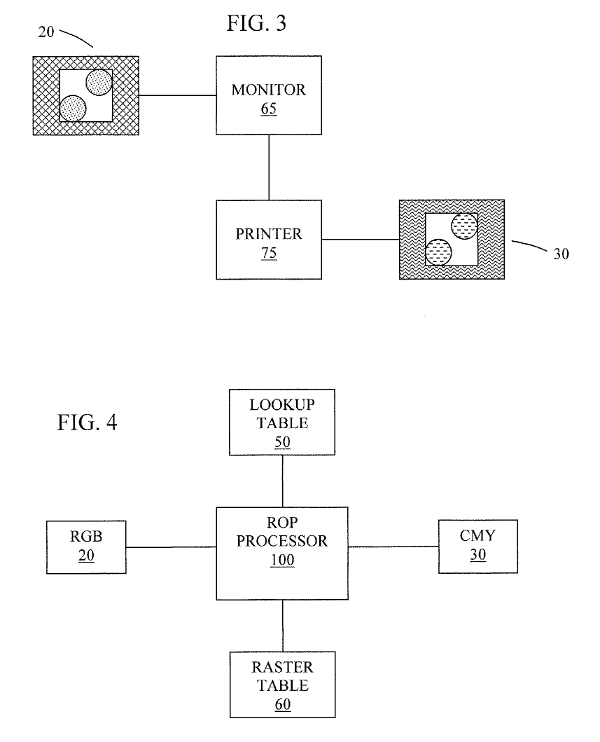

FIG. 3 illustrates an example block diagram of a raster operation (ROP) system including a monitor 65 and a printer 75. The monitor 65 may include any conventional display device used to project an image, such as the RGB image 20. The printer 75 may include any graphic device capable of printing an image on a printed media. In one embodiment, the RGB image 20 undergoes a halftoning process before being converted to the CMY space. The CMY image 30 is then printed by the printer 75. In another embodiment, the CMY image 30 undergoes a halftoning process, and a printed image is rendered from the CMY image 30. The printer 75 then prints the printed image as an approximate likeness of the RGB image 20 as converted to the CMY color space.

FIG. 4 illustrates an example block diagram of a ROP system including a lookup table 50 and a raster table 60. The ROP system is further shown as including a ROP processor 100. The ROP processor 100 may be provided in a computer, graphic device, printer or other device including processing capability. The ROP processor 100 may perform raster image operations on the RGB image 20 or the CMY image 30. The ROP processor 100 may utilize the raster table 60 to determine which logical operations to perform on the RGB image. The ROP processor 100 may further perform color halftoning of the RGB image 20 or the CMY image 30. In one embodiment, a separate processor (not shown) performs the color haltoning.

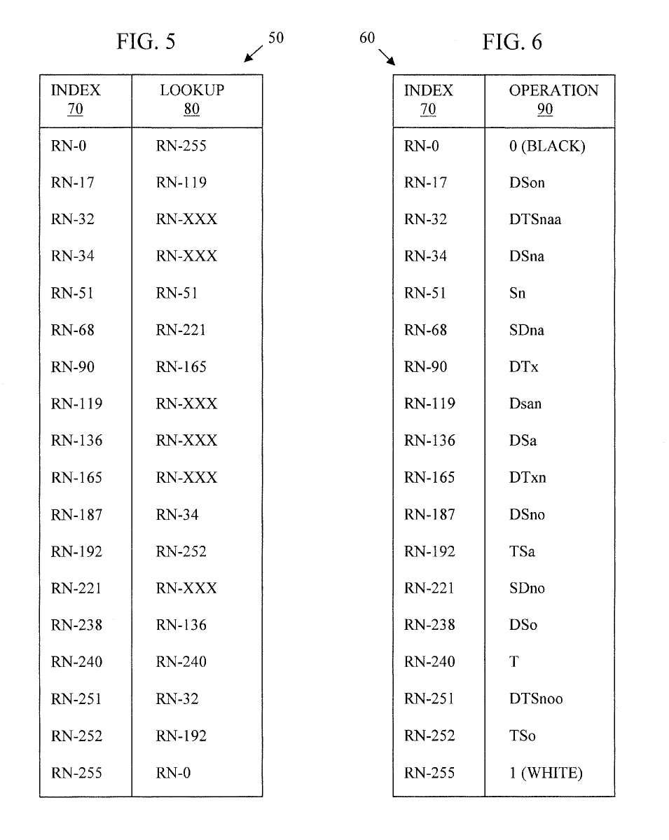

FIG. 5 illustrates an example lookup table such as lookup table 50 shown in FIG. 4. The lookup table 50 may include a set of index numbers 70 and an associated set of lookup numbers 80. Lookup table 50 is provided as an illustrative embodiment of how the index numbers 70 and lookup numbers 80 may be organized. In one embodiment, only the lookup numbers 80 are provided as entries in a lookup table, and the index numbers 70 correspond to the number of entries in the lookup table. The index numbers 70 may be associated with the lookup numbers 80 according to the order of the entries. In the illustrative example, a total of eighteen entries are shown, although different, more or fewer entries may be provided.

In one embodiment, the lookup table 50 includes 256 entries. The first entry of the lookup table 50 is identified by an index number or reference number RN-0 in the list of index numbers 70, corresponding to a lookup number RN-255 in the list of lookup numbers 80. The last entry of the lookup table 50 is identified by reference number RN-255, corresponding to the lookup number RN-255

FIG. 6 illustrates an example raster table such as raster table 60 shown in FIG. 4. The raster table 60 may include a set of index numbers 70 and an associated set of logical operations 90. The example index numbers 70 and logical operations 90 shown in FIG. 6 include some of the Microsoft Windows ternary raster operation codes known in the art as ROP3. The raster table 60 may be understood as including some or all of the ROP3 codes and associated logical operations. Raster table 60 is provided as an illustrative embodiment of how the index numbers 70 and logical operations 90 may be organized. In one embodiment, only the logical operations 90 are provided as entries in a raster table, and the logical operations 90 correspond to the number of entries in the raster table. The logical operations 90 may be associated with the index numbers 70 according to the order of the entries. In the illustrative example, a total of eighteen entries are shown, although different, more or fewer entries may be provided.

The number of entries in the lookup table 50 and the raster table 60 of FIGS. 5 and 6 may be the same. As shown, both tables include 18 entries; the 18 entries may be a partial listing of the available entries. In one embodiment, both tables include 256 entries. In one embodiment, the entries in the lookup table 50 are combined with the entries in the raster table 60 to form a single table including index numbers 70, lookup numbers 80 and logical operations 90. Lookup numbers RN-XXX may correspond to further or different index numbers 70 of the raster table 60, not shown in FIG. 6.

The lookup table 50 may be used to lookup, convert or map a first logical operation associated with one of the index number 70 with a second logical operation associated with one of the lookup numbers 80. For example, the first entry in the lookup table 50 identified as reference number RN-0 is associated with a lookup number RN-255. The raster table 60 associates a first logical operation of 0 (BLACK) with the reference number RN-0. The raster table 60 associates a second logical operation of 1 (WHITE) with the reference number RN-255.

The index numbers 70 may be generated by performing combinations of logical operations on the operands. By convention the operand T for texture may be assigned an 8 bit number of 111000. Operand S for source image may be assigned an 8-bit number of 11001100. Also, by convention, operand D for destination image may be assigned an 8-bit number of 1111100. Performing multiple combinations of the logical functions AND, OR, NOT and XOR on the operands T, S and D may result in 256 logical operations. Logical operations 90 shown in FIG. 6 are represented in reverse polish notation (RPN), as is known in the art. The logical functions may be abbreviated as a, o, n and x, respectively.

For example the logical operation of source image AND (texture OR destination image), abbreviated as SDToa provides a decimal result of 200 when operating on the 8-bit convention numbers designated above. According to the above convention, the reference number 200 in raster table 60 may therefore be assigned to the logical operation SDToa. Other combinations of logical functions and operands may be performed to determine other corresponding assignments between the index numbers 70 and the logical operations 90 in raster table 60.

Depending on the rendering method selected, the raster operation (ROP) may be performed on the RGB image 20 or on the CMY image 30. Where the raster operation is performed in RGB space, the logical operations 90 may be selected directly from the raster table 60. For example, reference number 252 may be selected from the list of index numbers 70 to operate on the RGB image 20. Reference number 252 corresponds to logical operation TSo.

By way of example, assume that the RGB texture 5 of FIG. 1 is designated by the RGB color tuple of (0,1,1) and the source image 10 of FIG. 1 is designated by the color tuple of (0,0,0) on a white background (1,1,1). For simplification, a bi-tonal representation of the color tuples are discussed for this and the following examples, where each tuple is represented by a single bit as being on (1) or off (0). Performing the logical operation TSo provides the resultant bits of (0,1,1) on a white background (1,1,1). The resultant bits of the raster operation may then be inverted into CMY space as (1,0,0) and (0,0,0) to obtain the corresponding device CMY operand values.

Where the raster operation is performed in the CMY space, the logical operations 90 may be selected with the assistance of the lookup table 50. The lookup table 50 includes a conversion index numbers or lookup numbers 80 corresponding to the logical operations 90 identified in the raster table 60. For example, lookup number RN-192 corresponds to the logical operation TSa. The logical operation TSa corresponding to lookup number RN-192 is used to operate on the one or more CMY operands defined in a second color space, namely the CMY color space.

After an initial selection of logical operation TSo corresponding to reference number RN-252 in the above RGB space example, the lookup table 50 maps the reference number RN-252 to lookup number RN-192. Lookup number RN-192 corresponds to the logical operation TSa. Whereas the logical operation TSo was used during the raster operation in the RGB color space, the logical operation TSa is selected during a raster operation in the CMY color space.

The logical operation of the one or more operands in the second color space is equivalent to the raster image operation performed on the one or more RGB operands. Performing the logical operation TSa on the operated-on operands of the CMY color space provides the resultant bits of (1,0,0) on a white background (0,0,0). This is the same result as obtained by applying the logical operation of TSo in the RGY color space.

The lookup table 50 thereby provides a means of utilizing the raster table 60 and the logical operations 90 contained therein to perform a raster operation in the CMY color space. The raster operation may be performed in the CMY color space either before or after any color halftoning operation.

The lookup table 50 may be generated prior to any raster operation and stored in a database. The database may include both the lookup table 50 and the raster table 60. The ROP processor 100 of FIG. 4 may access the lookup table 50 and the raster table during a raster operation. The lookup numbers 80 in the lookup table 50 may be generated or determined by analyzing the raster operation in the RGY color space, converting the resultant bits to CMY space and determining a simplified logical operation. For example, the logical operations associated with the CMY operands may be determined by first applying the logical operation associated with the RGB color space on the RGB operands, and then inverting the resultant bits. The resultant bits may be compared to the CMY operands to determine a simplified logical operation that would provide the same result. Whereas the logical operations associated in the CMY color space correspond with the lookup numbers 80, the logical operations associated with the RGB color space correspond with the reference index numbers 70.

Using the previous example including the RGB color tuple of (0,1,1) for the RGB texture 5 of FIG. 1 and the RGB color tuples of (0,0,0) and (1,1,1) for RGB source image 10, we can determine how to map the logical operation of TSo corresponding to reference number RN-252 to the CMY color space. Performing the logical operation TSo provides the resultant bits of (0,1,1) on a white background (1,1,1). The resultant bits of the raster operation may then be inverted into CMY space as (1,0,0) and (0,0,0) to obtain the corresponding device CMY operand values.

The RGB operands are operated on to bitwise invert the RGB color tuples to produce a CMY color tuple of (1,0,0) corresponding to a CMY texture 35 of FIG. 2. and CMY color tuples of (1,1,1) and (0,0,0) corresponding to CMY source image 40. By comparing the inverted resultant bits from the RGB logical operation, it can be shown that a logical operation of the CMY operands including the AND logical function will provide the same resultant bits. As such, the lookup number RN-192 corresponding to TSa may be mapped to the reference number RN-252. All of the index numbers 70 may be similarly mapped to the lookup numbers 80 in the lookup table. By completing this analysis and determining the simplified logical operations, a set of mapping rules may be determined. For example, the mapping rules may include the following:

A reference index number, such as reference number RN-240 including a single operand is mapped to itself through a conversion index number, such as lookup number RN-240.

A reference index number, such as reference number RN-255, associated with a white image maps to a conversion index number, such as lookup number RN-0 associated with a black image.

A reference index number, such as reference number RN-0, associated with a black image maps to a conversion index number, such as lookup number RN-255, associated with a white image.

A reference index number, such as reference number RN-238, including the logical function OR is mapped to a conversion index number, such as lookup number RN-136, that replaces OR with AND.

A reference index number, such as reference number RN-192, including the logical function AND is mapped to a conversion index number, such as lookup number RN-252, that replaces AND with OR.

A reference index number, such as reference number RN-51, including a logical function of a single NOT is mapped to itself through a conversion index number, such as lookup number RN-51.

A reference index number, such as reference number RN-90, including a logical function of XOR is mapped to a conversion index number, such as lookup number RN-165, which inverts the XOR logical function.

In one embodiment, a system such as the ROP system of FIG. 4 is configured to select a raster image operation. The system may include a raster macro table, such as raster table 60 of FIG. 4. The raster table may include a reference index number, such as one of the index numbers 70 of FIG. 5. The reference index number may represent a first logical operation of one or more operands in the first color space. The one or more operands may include texture, source image and destination image. The system may also include a lookup table, such as lookup table 60 of FIG. 4. The lookup table may include a conversion index number, such as one of the lookup numbers 80 of FIG. 5. The conversion index number may represent a second logical operation of one or more operated-on operands in the second color space. The conversion index number may be mapped to the reference index number, where a designation of the reference index number results in an application of the second logical operation rather than, and different from, the first logical operation.

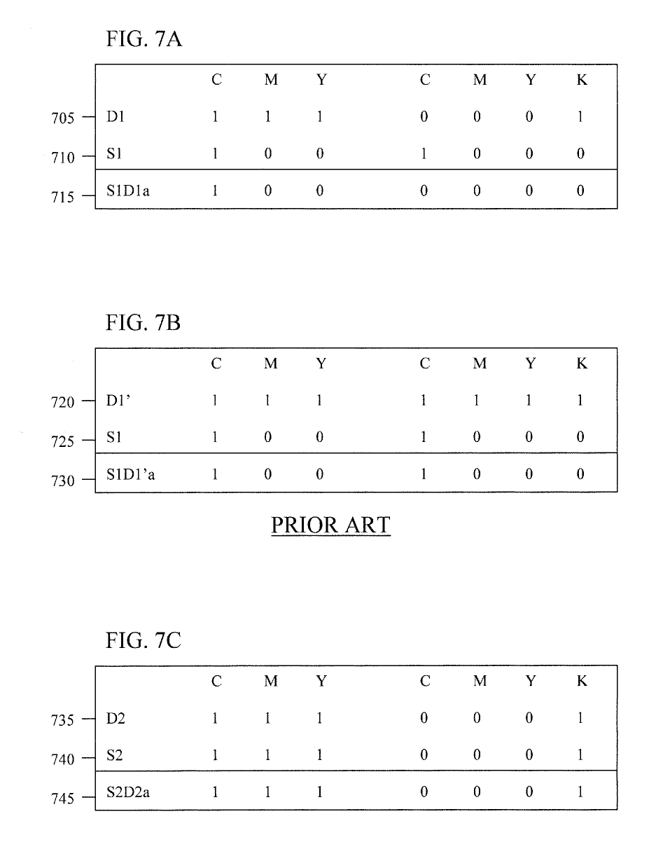

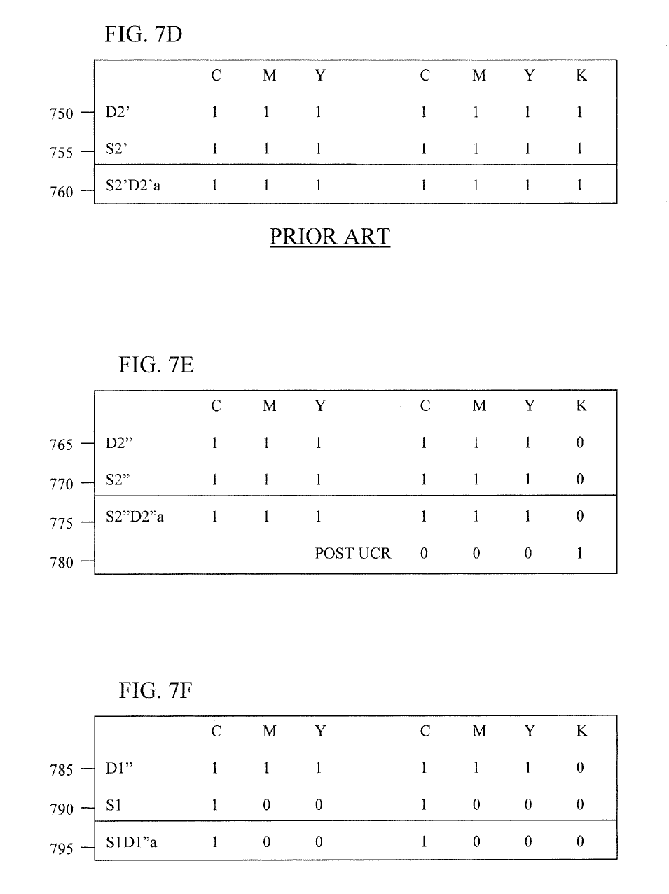

FIG. 7A illustrates an example logical operation for an incompatible raster image operation between CMY and CMYK color spaces. The CMYK color space may be selected for the graphic device (printer) whereas a raster operation or halftoning process may be performed in the CMY color space. In the example rendering process, a destination image D1 and a source image S1 set of values have been defined in the CMY color space and CMYK color space. At line 705, D1 may be defined as (1,1,1) in the CMY color space and as (0,0,0,1) in the CMYK color space. At line 710, S1 may be defined as (1,0,0) in the CMY color space and as (1,0,0,0) in the CMYK color space.

At line 715, a logical operation of S1 and D1 (S1D1a) is performed on the source image S1 and the destination image D1. Performing the logical operation S1D1a in the CMY color space provides the resultant color tuple of (1,0,0), which identifies cyan C. However, if the logical operation is performed on the CMYK color space, it is noticed that the resultant color values are (0,0,0,0), which identifies white. The results performing the logical operation of S1D1a in the CMY and CMYK color spaces are incompatible.

FIG. 7B illustrates a revised logical operation to address incompatible raster image operations between the CMY and CMYK color spaces, known in the art. In this process, where the color value for K is detected for an image, the color values for CMY are also enabled, or set to (1). For example, the CMYK destination image D1 shown in FIG. 7A has color values of (0,0,0,1) and at line 720 of FIG. 7B is operated on as D1′ to present new color values of (1,1,1,1). Both color values (0,0,0,1) and (1,1,1,1) may be understood as identifying the color black. The color values for the source image S1 defined by the color values (1,0,0,0) at line 710 of FIG. 7A are not operated on at line 725, and the same color value is therefore retained as S1.

Performing the logical operation of S1 and D1′ (S1D1′a) at line 730 provides the resultant bits of (1,0,0,0). Color value (1,0,0,0) may be understood as identifying the color cyan in the CMYK color space. The logical operation of S1D1′a in the CMY color space, see line 730, results in the CMY color tuple of (1,0,0). As previously discussed with respect to line 715 of FIG. 7A, this also may be identified as the color cyan. The results of performing the logical operation of S1D1′a in the CMY and CMYK color spaces are compatible.

FIG. 7C illustrates a further example logical operation for a raster image operation between CMY and CMYK color spaces. In the example rendering process, a destination image D2 and a source image S2 set of values have been defined in the CMY color space and CMYK color space. At line 735, D2 may be defined as (1,1,1) in the CMY color space and as (0,0,0,1) in the CMYK color space. At line 740, S2 may be defined as (1,1,1) in the CMY color space and as (0,0,0,1) in the CMYK color space.

At line 745, a logical operation of S2 and D2 (S2D2a) is performed on the source image S2 and the destination image D2. Performing the logical operation S2D2a in the CMY color space provides the resultant color tuple of (1,1,1), which identifies black. If the logical operation is performed on the CMYK color space, the resultant color values are (0,0,0,1), which also identifies black. The results of performing the logical operation of S2D2a in the CMY and CMYK color spaces are compatible.

FIG. 7D illustrates a revised logical operation of the raster image operation shown in FIG. 7C, known in the art. The revised logical operation previously described with reference to FIG. 7B is now applied to the source image S2 and the destination image D2 of FIG. 7C. At line 750, the CMYK destination image D2 identified by color values (0,0,0,1) is operated on as D2′ to present new color values of (1,1,1,1). Similarly, at line 755 the CMYK source image S2 identified by color values (0,0,0,1) is operated on as S2′ to present new color values of (1,1,1,1).

Performing the logical operation of S2′ and D2′ (S2′D2′) at line 760 provides the resultant bits of (1,1,1,1). As previously discussed, the logical operation S2D2a performed on the original CMYK color values at line 745 of FIG. 7C provides the resultant color values as (0,0,0,1). While both (1,1,1,1) and (0,0,0,1) may be understood as identifying the color black, the resulting bits (1,1,1,1) shown at line 760 for the revised logical operation results in an over-saturation state. Requesting a printer to use color toner for C, M and Y in addition to K may result in an excessive use of color toner, where the use of color toner for K alone may have sufficed to represent the color black.

FIG. 7E illustrates an example of an improved logical operation in the CMYK color space, with reference to the raster image operation shown in FIG. 7C. In this example process, where the color value for K is detected as being enabled for either source or destination image, the color values for CMY are enabled, or set to (1), while the bit value for K is set to (0). For example, the CMYK destination image D2 shown at line 735 of FIG. 7C has color values of (0,0,0,1) and when detected at line 765, the destination image is operated on as D2″ to present new color values of (1,1,1,0). The CMYK source image S2 shown at line 740 of FIG. 7C has color values of (0,0,0,1) and when detected at line 770, the source image is operated on as S2″ to present new color values of (1,1,1,0). The color value (0,0,0,1) shown at lines 735 and 740 of FIG. 7C and the color values of (1,1,1,0) shown at lines 765 and 770 may be understood as identifying the color black.

The improved process illustrated by FIG. 7E may then perform a post under color removal operation at line 780 that generates the K component while zeroing out the CMY color values, providing the resultant bits of (0,0,0,1). These are the same resultant bits identified by the operation S2D2a at line 745 of FIG. 7C. Since both (1,1,1,0) and (0,0,0,1) identify the color black, there is no loss of color information during the under color removal operation. In one embodiment, the problem of over-saturation is solved, since only color toner for black (K) is used to print the color black.

FIG. 7F illustrates a further example of an improved logical operation in the CMYK color space, with reference to the raster image operation shown in FIG. 7A. The improved logical operation previously described with reference to FIG. 7E may be applied to the source image S1 and the destination image D1 of FIG. 7A. The CMYK destination image D1 shown at line 705 of FIG. 7A has color values of (0,0,0,1) and when detected at line 785, the destination image is operated on as D1″ to present new color values of (1,1,1,0). In one embodiment, the color values for the source image S1 defined by the color values (1,0,0,0) at line 710 of FIG. 7A is not operated on at line 790, and the same color value may therefore be retained as S1. The CMYK color value (0,0,0,1) shown at lines 705 of FIG. 7A and the CMYK color values of (1,1,1,0) shown at line 785 may be understood as identifying the color black. The CMYK color value (1,0,0,0) shown at lines 710 of FIG. 7A and the CMYK color values of (1,0,0,0) shown at line 790 may be understood as identifying the color cyan.

Performing the logical operation of S1 and D2′ (S1D2′a) at line 795 provides the resultant bits of (1,0,0,0). Color value (1,0,0,0) may be understood as identifying the color cyan in the CMYK color space. The logical operation of S1D2′a in the CMY color space, see line 795, results in the CMY color tuple of (1,0,0). As previously discussed with respect to line 715 of FIG. 7A, this also may be identified as the color cyan. The results of performing the improved logical operation of S1D2′a in the CMY and CMYK color spaces are compatible. There is no loss of color information during the under color removal operation.

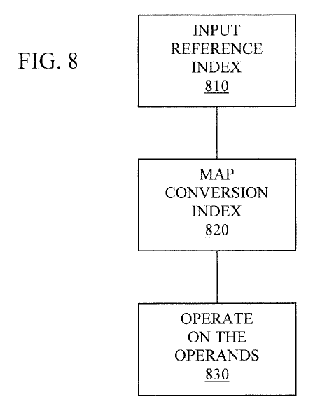

FIG. 8 illustrates an example method of an improved raster operation, At operation 810 a reference index number is selected corresponding to a first logical operation associated with a first set of operands. The reference index number may be selected from a list of reference numbers such as index number 70 of FIG. 5. The first logical operation may be identified in a raster table, such as raster table 60 of FIG. 6, including logical operations 90.

At operation the reference index number is mapped to a conversion index number, where the conversion index number corresponds to a second logical operation different than the first logical operation. The conversion index number may be identified from a list of conversion numbers, such as lookup numbers 80 of FIG. 5. The second logical operation may be identified in a raster table, such as raster table 60 of FIG. 6. The conversion index number may identify a numerically equivalent reference index number in the raster table 60 which corresponds to the second logical operation.

At operation 830 a second set of operands is operated on according to the second logical operation, the first set of operands being associated with a first color space, and the second set of operands being associated with a second color space.

In one embodiment, performing the first logical operation on the first set of operands in the first color space provides a same raster image operation result as performing the second logical operation on the second set of operands in the second color space.

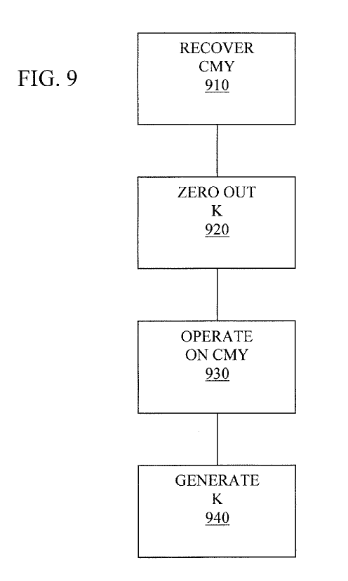

FIG. 9 illustrates an example method for improved color management, including a method of converting data between a first color space and a second color space. In one embodiment, the example method may be understood with reference to the process illustrated in FIG. 7C, including one or more operands identified by color components cyan, magenta, yellow, and black (CMYK). In one embodiment, the CMYK color space may be understood as being the second color space, whereas the CMY color space may be understood as being the first color space.

At operation 910 the CMY components are recovered from K in an under color removal operation. For example, where one or more of the CMY components or bits were previously disabled or turned off (0), they may now all be enabled or turned on (1) when recovered from an enabled K component.

At operation 920 the K component is zeroed out prior to operating on the second set of operands. If the K component was previously enabled or turned on (1), then it would be disabled or turned off (0) when its associated bit or bits are inverted.

At operation 930 the second set of operands are operated on. The second set of operands are operated on according to a logical operation, for example one of the logical operations 90 identified in raster table 60 of FIG. 6.

At operation 940 the K component is recovered in a post under color removal operation after operating on the second set of operands. If the CMY components are all enabled or turned on (1), then this results in a color tuple of (1,1,1). In the CMYK space, this is equivalent to (1,1,1,0). In this case, the K component may be recovered from the CMY components by enabling or turning on the K component. This may be shown by CMYK color values (0,0,0,1) where the CMY components have been disabled or set to (0). The improved method provides compatible color rendering between the CMY and CMYK color spaces without introducing over-saturation.

In one embodiment, performing the first logical operation on the first set of operands in the first color space provides a same raster image operation result as performing the second logical operation on the second set of operands in the second color space.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A conversion table comprising:
a conversion index number corresponding to a logical operation identified in a raster table, where the conversion index number provided in the conversion table is mapped from a reference index number provided in the raster table associated with a raster image operation of one or more RGB operands defined in a first color space, to provide the logical operation associated with one or more operands defined in a second color space.

2. The conversion table according to claim 1 where the conversion index number is mapped from the reference index number according to the following mapping rule:
the logical operation of the one or more operands in the second color space is equivalent to the raster image operation performed on the one or more RGB operands.

3. The conversion table according to claim 1 where the conversion index number is mapped from the reference index number according to the following mapping rules:
the reference index number associated with a white image maps to the conversion index number associated with a black image;
the reference index number associated with the black image maps to the conversion index number associated with the white image;
the reference index number including a logical function OR is mapped to a conversion index number that replaces OR with AND;
the reference index number including a logical function AND is mapped to a conversion index number that replaces OR with AND; and
the reference index number including a logical function of XOR is mapped to a conversion index number that inverts the XOR logical function.

4. The conversion table according to claim 3 where the reference index number is mapped from the conversion index number according to the additional following mapping rules:
the reference index number including a single operand is mapped to itself; and
the reference index number including a logical function of a single NOT is mapped to itself.

5. The conversion table according to claim 1 where the first color space is associated with a projected image and the second color space is associated with printed media.

6. The conversion table according to claim 1 where the logical operation includes AND, OR, XOR and NOT and the one or more operands include source, texture and destination.

7. A system for selecting a raster image operation comprising:
a raster macro table including a reference index number representing a first logical operation of one or more RGB operands in a first color space; and
a lookup table including a conversion index number representing a second logical operation of one or more operands in a second color space, the reference index number being mapped to the conversion index number, where a designation of the reference index number results in an application of the second logical operation rather than, and different from, the first logical operation.

8. The system according to claim 7 where the reference index number is mapped to the conversion index number according to the following mapping rule:
the first logical operation of the one or more operands associated with the conversion index number is equivalent to the second logical operation performed on the one or more RGB operands.

9. The system according to claim 7 where the reference index number is mapped to the conversion index number according to the following mapping rules:
the reference index number associated with a white image maps to the conversion index number associated with a black image;
the reference index number associated with the black image maps to the conversion index number associated with the white image;
the reference index number including a logical function OR is mapped to a conversion index number that replaces OR with AND;
the reference index number including a logical function AND is mapped to a conversion index number that replaces OR with AND; and
the reference index number including a logical function of XOR is mapped to a conversion index number that inverts the XOR logical function.

10. The system according to claim 9 where the reference index number is mapped to the conversion index number according to the additional following mapping rules:
the reference index number including a single operand is mapped to itself; and
the reference index number including a logical function of a single NOT is mapped to itself.

11. The system according to claim 7 where the first color space is a red, green, blue (RGB) color space, and the second color space is a cyan, magenta, yellow (CMY) color space.

12. The system according to claim 7 where performing the first logical operation on the one or more RGB operands in the first color space provides a same raster image operation result as performing the second logical operation on the one or more operands in the second color space.

13. A method for selecting a raster image operation comprising:
selecting a reference index number corresponding to a first logical operation associated with a first set of operands;
mapping the reference index number to a conversion index number, where the conversion index number corresponds to a second logical operation different than the first logical operation; and
operating on a second set of operands according to the second logical operation, the first set of operands being associated with a first color space, and the second set of operands being associated with a second color space

14. The method according to claim 13 where the second set of operands are identified by color components cyan, magenta, yellow, and black (CMYK).

15. The method according to claim 14 further comprising:
recovering the CMY components from K; and
zeroing out the K component prior to operating on the second set of operands.

16. The method according to claim 15 including generating the K component in a post under color removal operation after operating on the second set of operands.

17. The method according to claim 13 where performing the first logical operation on the first set of operands in the first color space provides a same raster image operation result as performing the second logical operation on the second set of operands in the second color space.

18. The method according to claim 13 where the reference index number is mapped to the conversion index number according to the following mapping rule:
the logical operation of the second set of operands associated with the conversion index number is equivalent to an inverse of a raster logical operation performed on the first set of operands, where the raster logical operation is associated with the reference index number.

19. The method according to claim 13 where the reference index number is mapped to the conversion index number according to the following mapping rules:
the reference index number associated with a white image maps to the conversion index number associated with a black image;
the reference index number associated with the black image maps to the conversion index number associated with the white image;
the reference index number including a logical function OR is mapped to a conversion index number that replaces OR with AND;
the reference index number including a logical function AND is mapped to a conversion index number that replaces OR with AND; and
the reference index number including a logical function of XOR is mapped to a conversion index number that inverts the XOR logical function.

20. The method according to claim where the reference index number is mapped to the conversion index number according to the additional following mapping rules:
the reference index number including a single operand is mapped to itself; and
the reference index number including a logical function of a single NOT is mapped to itself.
